(19) United States
(12) Patent Application Publication
(10) Pub. No.: US 2015/0311540 A1
(43) Pub. Date: Oct. 29, 2015

(54) METHOD FOR PRODUCING FLUID FLOW FIELD PLATES

(71) Applicant: EnergyOr Technologies Inc, Saint-Laurent (CA)

(72) Inventors: THOMAS DAVID JONES, Montreal (CA); Michel Meyer Bitton, Ville Saint-Laurent (CA)

(73) Assignee: ENERGYOR TECHNOLOGIES INC., MONTREAL (CA)

(21) Appl. No.: 14/264,533

(22) Filed: Apr. 29, 2014

(51) Int. Cl. H01M 8/02

(52) U.S. Cl. CPC H01M 8/0267; H01M 8/026; H01M 8/0254

(57) ABSTRACT

Disclosed herein is a method for producing fluid flow field plates. The method includes cutting through an electrically conductive sheet to create at least one opening for a fluid in the sheet; and embossing the sheet to create therein at least one support for the at least one opening for a fluid.

### BACKGROUND

The present generally concerns electrochemical fuel cells and more particularly to a method for fabricating fluid flow field plates with complex flow field geometries.

Polymer electrolyte membrane or proton exchange membrane (PEM) fuel cell systems have intrinsic benefits and a wide range of applications due to their relatively low operating temperatures and good balance of both power and energy density. The active portion of a PEM cell is a membrane sandwiched between an anode and a cathode layer. Fuel containing hydrogen is passed over the anode and oxygen (air) is passed over the cathode. The reactants, through the electrolyte (membrane), react indirectly with each other generating an electrical voltage between the cathode and anode. Typical electrical potentials of PEM cells can range from 0.5 to 0.9 volts where the higher the cell voltage, the greater the electrochemical efficiency. At lower cell voltages, the current density is higher but there is eventually a peak value in power density for a given set of operating conditions. The electrochemical reaction also generates heat and water as byproducts that must be extracted from the fuel cell, although the extracted heat can be used in a cogeneration mode, and the product water can be used for humidification of the membrane, cell cooling or dispersed to the environment.

Multiple cells are combined by stacking, interconnecting individual cells in an electrical series configuration. The voltage generated by the fuel cell stack is effectively the sum of the individual cell voltages. There are designs that use multiple cells in parallel or in a combination series-parallel connection. Fluid flow field plates are inserted between the cells to separate the anode reactant of one cell from the cathode reactant of the next cell. These plates are typically graphite based or metallic (with or without coating). To provide hydrogen to the anode and oxygen to the cathode without mixing, a system of fluid distribution and seals is required.

The dominant design at present in the fuel cell industry is to use fluid flow field plates with the flow fields machined, molded or otherwise impressed. An optimized flow field plate has to fulfill a series of requirements: very good electrical and heat conductivity; gas tightness; corrosion resistance; low weight; and low cost. The fluid flow field plate design ensures good fluid distribution as well as the removal of product water and heat generated. Manifold design is also critical to uniformly distribute fluids between each separator/flow field plate.

There is an ongoing effort to innovate in order to increase the power density (reduce weight and volume) of fuel cell stacks, and to reduce material and assembly costs.

In a fuel cell system (stack & balance of plant), the stack is the dominant component of the fuel cell system's weight and cost and the fluid flow field plates are the major component (both weight and volume) of the stack.

Fluid flow field plates are a significant factor in determining the gravimetric and volumetric power density of a fuel cell, typically accounting for 40 to 70% of the weight of a stack and almost all of the volume. For component developers, the challenge is therefore to reduce the weight, size and cost of the fluid flow field plate while maintaining the desired properties for high-performance operation.

The material for the fluid flow field plate must be selected carefully due to the challenging environment in which it operates. In general, it must possess a particular set of properties and combine the following characteristics:
High electrical conductivity, especially in through-plane direction
Low contact resistance with the gas diffusion layer (GDL)
High thermal conductivity, both in-plane and through-plane
Good thermal stability, limiting expansion and contraction due to temperature variations
Good mechanical strength and resistance to cracking
Able to maintain good feature tolerance for flow fields, etc.
Fluid impermeability to prevent reactant and coolant leakage, especially for the case of gaseous hydrogen
Corrosion resistance
Resistance to ion-leaching, so as not to contaminate the membrane electrode assembly (MEA)
Thin and lightweight
Low cost and ease of manufacturing
Recyclable
Environmentally benign

A number of different methods have been used to manufacture fluid flow field plates including for example, U.S. Pat. No. 5,300,370 to Washington et al for “Laminated Fluid Flow Field Assembly for Electrochemical Fuel Cells” on Apr. 5, 1994. This patent describes a laminated fluid flow field assembly comprising a separator layer and a stencil layer, where in operation, the separator layer and stencil layer cooperate to form an open faced channel for conducting pressurized fluids. Although this patent is namely for discontinuous flow field configurations, it also addresses continuous flow field designs. This method, however, has a number of significant drawbacks which focus mainly on the fabrication of the stencil layer. When the flow channels in the stencil layer are formed, material is removed from the flow field plate, and therefore the remaining channel landings are left unsupported. Effectively, the landings of the stencil layer plate would move indiscriminately, therefore leaving the stencil layer to be very difficult to handle and position. Further, the tolerance required for the correct flow channel width to ensure accurate fluid flow distribution per channel would not be maintained, especially for the continuous flow field design.

Another example is provided in U.S. Pat. No. 5,521,018 to Wilkinson et al for “Embossed Fluid Flow Field Plate for Electrochemical Fuel Cells” on May 28, 1996. This patent namely describes an embossed fluid flow field plate comprising two sheets of compressible, electrically conductive material, where each sheet has two oppositely facing major surfaces, where at least one of the major surfaces has an embossed surface which has a fluid inlet and at least one open-faced channel embossed therein. A metal sheet is interposed between each of the compressible sheets. Although this patent focuses mainly on embossed fluid flow field plates, it provides an example of a coolant flow field plate where a single coolant flow channel is die-cut and the sealant channel is embossed. It is indeed an advantage to have a single channel joining the fluid inlet and fluid outlet when removing material to form the flow channel, as in this case, since the perimeter of the channel is effectively supported. With that said, the channel is of a complex, serpentine geometry and even though it is supported around the perimeter, the landings are not supported within the plate, therefore making it impractical to handle and position after it is fabricated.

U.S. Pat. No. 5,683,828 to Spear et al for “Metal Platelet Fuel Cells Production and Operation Methods” on Nov. 4, 1997 describes fuel cell stacks comprising stacked separator/membrane electrode assembly cells in which the separators comprise a series of stacked thin sheet platelets having individually configured serpentine micro-channel reactant gas humidification, active area and cooling fields within. Although this patent outlines a method to fabricate a metal platelet comprising a complex serpentine flow geometry which is supported throughout by a means to maintain the correct flow channel spacing, thereby allowing the platelet to be easily handled after fabrication without the flow channel landings shifting, the method described for manufacturing these flow channel supports is depth etching, which is a relatively costly manufacturing method and does not lend itself to higher volume production.

Thus, there is a need for an improved method for fabricating fluid flow field plates with complex fluid flow field geometries.

### BRIEF SUMMARY

We have designed a low cost method for producing lightweight fluid flow field plates with complex flow field geometries. The method involves cutting through a sheet of flexible graphite while simultaneously embossing fluid flow field channel supports, and then finishing the cut sheet. Unlike the examples described above, our method produces a practical fluid flow field plate with complex flow field geometries that is easily handled. It requires only die cutting flow channels and manifolds while simultaneously embossing channel supports, and then finishing the part by pressing. Our method cuts all flow channels/manifolds and embosses channel supports in one step, and the “finishing” step does not require careful part alignment. Furthermore, our method only requires one die per part.

Accordingly, there is provided a method for producing fluid flow field plates with complex flow field geometries, the method comprising:
cutting through an electrically conductive sheet to create therein at least one opening for a fluid; and
embossing the sheet to create therein at least one support for the at least one opening for a fluid.

The method, as described above, further comprising:
finishing the cut/embossed sheet by pressing it between two rigid, flat plates.

In one example, the rigid, flat plates each include a non-stick coating.

The method, as described above, further comprising:
finishing the cut/embossed sheet by pressing it between two parallel rollers.

In one example, the parallel rollers each include a non-stick coating.

In another example, the cutting step is carried out using a die having at least one blade. The die has two blades. The die is a rule die, flexible die or solid engraved die. The two blades of the die are located side-by-side.

In another example, the embossing step is carried out using a die having at least one embossing feature. The die has two embossing features. The die is a rule die, flexible die or solid engraved die.

In another example, the cutting step and the embossing step are carried out simultaneously using a die having at least one blade and one embossing feature. The die has two blades and one embossing feature. The die has two blades and two embossing features. The die is a rule die, flexible die or solid engraved die. The two blades of the die are located side-by-side.

In another example, the cut/embossed plate includes at least one oxidant flow opening. The cut/embossed plate includes a plurality of oxidant flow openings. At least one oxidant inlet manifold opening and at least one oxidant outlet manifold opening located at the ends of the oxidant flow openings and in communication therewith.

In another example, the cut/embossed plate includes at least one fuel inlet manifold opening and at least one fuel outlet manifold opening.

In another example, the cut/embossed plate includes at least one fuel flow opening. The cut/embossed plate includes a plurality of fuel flow openings. The cut/embossed plate includes at least one fuel inlet manifold opening and at least one fuel outlet manifold opening which are located at the ends of the fuel flow openings.

In another example, the cut/embossed plate includes at least one coolant flow opening. The cut/embossed plate includes a plurality of coolant flow openings. At least one coolant inlet manifold opening and at least one coolant outlet manifold opening located at the ends of the coolant flow openings and in communication therewith.

In one example, the cut/embossed plate is an oxidant flow field plate.

In another example, the cut/embossed plate is a fuel flow field plate.

In another example, the cut/embossed plate is a coolant flow field plate.

In another example, the cut/embossed plate includes a plurality of oxidant inlet manifold openings and a plurality of oxidant outlet manifold openings.

In another example, the cut/embossed plate includes a plurality of fuel inlet manifold openings and a plurality of fuel outlet manifold openings.

In another example, the cut/embossed plate includes a plurality of coolant inlet manifold openings and a plurality of coolant outlet manifold openings.

In yet another example, the cut/embossed plate is a separator plate. The separator plate is a cooling fin separator plate

In one example, the electrically conductive sheet is flexible graphite.

According to another aspect, there is provided a method for producing fluid flow field plates with complex flow field geometries, the method comprising:
cutting through an electrically conductive sheet to create therein at least one opening for a fluid; and
embossing the sheet to create therein at least one support for the at least one opening for a fluid, the cutting through and embossing steps being carried out simultaneously.

### BRIEF DESCRIPTION OF THE DRAWINGS

These and other features of that described herein will become more apparent from the following description in which reference is made to the appended drawings wherein:

FIG. 1 is an exploded cutaway cross-sectional view of a two-fluid (i.e. air cooled) unit cell assembly configuration;

FIG. 2 is a top view of a fluid flow field plate including a plurality of elongate parallel flow openings;

FIG. 3 is an exploded cutaway cross-sectional view of a three-fluid (i.e. liquid cooled) unit cell assembly configuration;

FIG. 4 is a perspective top view of a fuel flow field plate showing a single-pass serpentine geometry comprising fluid flow field channel supports;

FIG. 5a is a top view of a fuel flow field plate comprising fluid flow field channel supports;

FIG. 5b is a bottom view of a fuel flow field plate comprising fluid flow field channel supports;

FIG. 6a is a top view of a coolant flow field plate showing a multi-pass serpentine geometry comprising fluid flow field channel supports;

FIG. 6b is a bottom view coolant flow field plate comprising fluid flow field channel supports;

FIG. 7a is a top view of a separator plate;

FIG. 7b is a bottom view of a separator plate;

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

As used herein, the term “flow field plate” is intended to mean a plate that is made from a suitable electrically conductive material. The material is typically substantially fluid impermeable, that is, it is impermeable to the reactants and coolants typically found in fuel cell applications, and to fluidly isolate the fuel, oxidant, and coolants from each other. In the examples described below, an oxidant flow field plate is one that carries oxidant, whereas a fuel flow field plate is one that carries fuel, and a coolant flow field plate is one that carries coolant. The flow field plates can be made of the following materials: graphitic carbon impregnated with a resin or subject to pyrolytic impregnation; flexible graphite; metallic material such as stainless steel, aluminum, nickel alloy, or titanium alloy; carbon-carbon composites; carbon-polymer composites; or the like. Flexible graphite, also known as expanded graphite, is one example of a suitable material that is compressible and, for the purposes of this discovery, easily cut through and embossed.

As used herein, the term “fluid” is intended to mean liquid or gas. In particular, the term fluid refers to the reactants and coolants typically used in fuel cell applications.

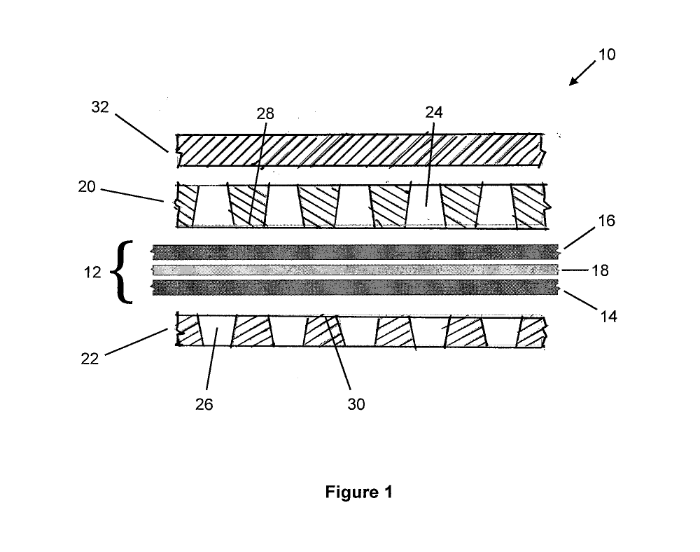

Referring now to FIG. 1 in which a repeating unit cell assembly of a two-fluid (i.e. air cooled) fuel cell stack is shown generally at 10. The fuel cell 10 comprises a Membrane Electrode Assembly (MEA) 12, which includes an anode 14, a cathode 16 and a solid electrolyte 18 located between the anode 14 and the cathode 16. The MEA 12 is located between an oxidant flow field plate 20 and a fuel flow field plate 22. A first plurality of oxidant flow channels 24 are located within the oxidant field flow plate 20 and between and the cathode 16 and a separator plate 32 to supply the oxidant to the cathode 16. A second plurality of fuel flow channels 26 are located within the fuel flow field plate 22 and between the anode 14 and the separator plate 32 (not shown) to supply fuel to the anode 14. A plurality of oxidant channel landings 28 are located on one side of the oxidant flow field plate 20, and fuel channel landings 30 are located on one side of the fuel flow field plate 22 and respectively intimately contact the cathode 16 and the anode 14 to allow the passage of electrical current through and heat from the MEA 12. The separator plate 32 is located in intimate contact with the oxidant flow field plate 20 and allows the axial passage of electrical current therealong. In the example illustrated, the separator plate 32 is a cooling fin separator plate which also laterally transfers heat to external cooling fins and acts as a separator between each repeating unit cell. Typically, when multiple cells are assembled, each fuel flow field plate 22 lies in intimate contact with a cooling fin separator plate 32, thereby sealing the channels 26.

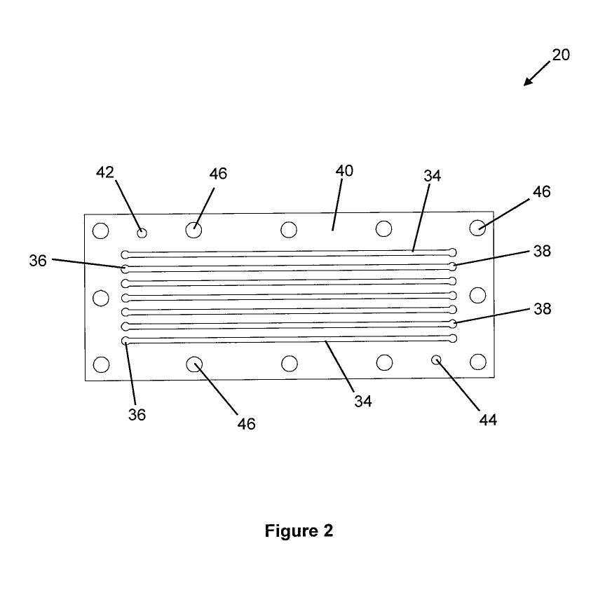

Referring now to FIG. 2, an individual fluid flow field plate 20 is shown, which in this case is an oxidant flow field plate. The plate includes at least one elongate oxidant flow channel 34. In the example shown, a plurality of elongate oxidant flow openings 34 are cut through the plate 20 and extend parallel to each other along the central portion of the plate 20. Each elongate oxidant flow opening 34 includes an oxidant inlet manifold opening 36 and an oxidant outlet manifold opening 38, which are located at each end of the elongate oxidant flow opening 34. The oxidant flow field plate 20 also includes a peripheral area 40, which forms a boundary around the elongate oxidant flow openings 34. A fuel inlet manifold opening 42 and a fuel outlet manifold opening 44 are cut through the peripheral area 40 and are located away from each other on opposite sides of the oxidant flow openings 34. A plurality of holes 46 to accommodate a stack compression system (not shown), are also cut through the peripheral area 40. Since the oxidant flow openings 34 are effectively straight and parallel, and are also well supported around the perimeter since each flow opening 34 has its own oxidant inlet manifold opening 36 and an oxidant outlet manifold opening 38, fluid flow field channel supports are generally not required for this configuration.

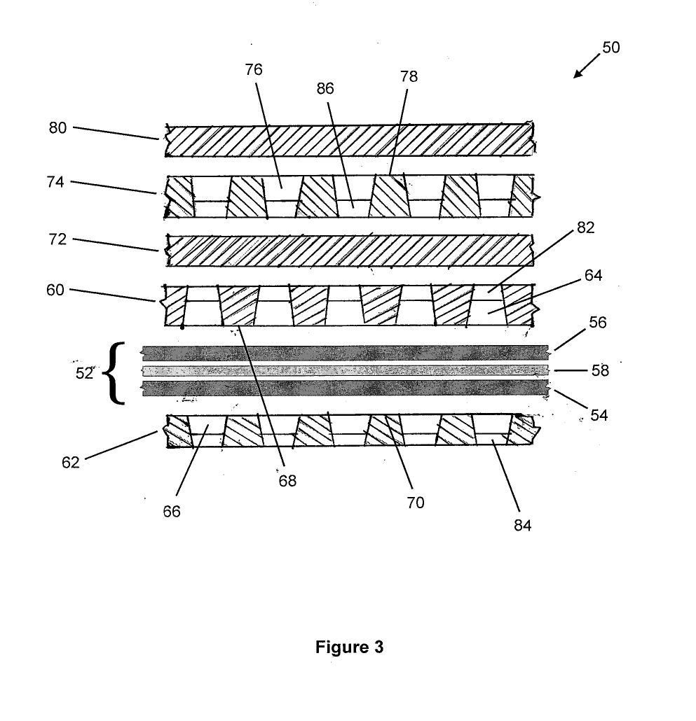

Referring now to FIG. 3 in which a repeating unit cell assembly of a three-fluid (i.e. liquid cooled) fuel cell stack is shown generally at 50. The fuel cell 50 comprises a Membrane Electrode Assembly (MEA) 52, which includes an anode 54, a cathode 56 and a solid electrolyte 58 located between the anode 54 and the cathode 56. The MEA 52 is located between an oxidant flow field plate 60 and a fuel flow field plate 62. A first plurality of oxidant flow channels 64 are located within the oxidant field flow plate 60 and between and the cathode 56 and a separator plate 72 to supply the oxidant to the cathode 56. A second plurality of fuel flow channels 66 are located within the fuel flow field plate 62 and between the anode 54 and the separator plate 80 (not shown) to supply fuel to the anode 54. A plurality of oxidant channel landings 68 are located on one side of the oxidant flow field plate 60, and fuel channel landings 70 are located on one side of the fuel flow field plate 62 and respectively intimately contact the cathode 56 and the anode 54 to allow the passage of electrical current through and heat from the MEA 52. The separator plate 72 is located in intimate contact with the oxidant flow field plate 60 and allows the axial passage of electrical current therealong. A third plurality of coolant flow channels 76 are located within a coolant flow field plate 74 and between the separator plate 72 and a separator plate 80 to supply liquid coolant to the unit cell assembly 50. A plurality of coolant channel landings 78 are located on one side of the coolant flow field plate 74 and are in intimate contact with separator plate 72 to allow the passage of electrical current through and heat from the MEA 52. At certain locations down the length of the oxidant flow channels 64, one or more oxidant flow field channel supports 82 are placed to maintain the correct spacing of oxidant flow channel 64. Likewise, at certain locations down the length of the fuel flow channels 66, one or more fuel flow field channel supports 84 are placed to maintain the correct spacing of fuel flow channel 66. Further, at certain locations down the length of the coolant flow channels 76, one or more coolant flow field channel supports 86 are placed to maintain the correct spacing of coolant flow channel 76. In the example illustrated the separator plate 80 acts as a separator between each repeating unit cell. Typically, when multiple cells are assembled, each fuel flow field plate 62 lies in intimate contact with a separator plate 80, thereby sealing the fuel flow field channels 66.

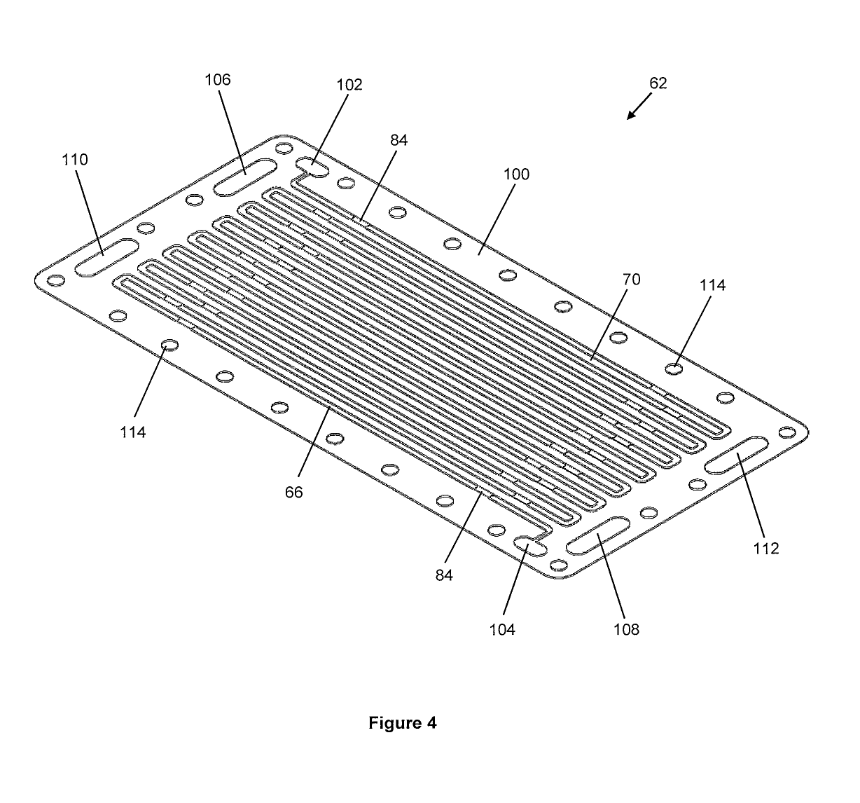

Referring now to FIG. 4, a general perspective top view of fuel flow field plate 62 is shown with single-pass serpentine flow field geometry. Fuel flow channels 66 are cut through fuel flow field plate 62 and comprise a number of fluid flow field channel supports 84 which are embossed and join fuel channel landings 70 and in several instances join with peripheral area 100. A fuel inlet manifold opening 102 and a fuel outlet manifold opening 104 are cut through the peripheral area 100. Similarly, an oxidant inlet manifold opening 106 and an oxidant outlet manifold opening 108, as well as a coolant inlet manifold opening 110 and a coolant outlet manifold opening 112, are also cut through the peripheral area 100. A plurality of holes 114 to accommodate a stack compression system (not shown), are also cut through the peripheral area 100.

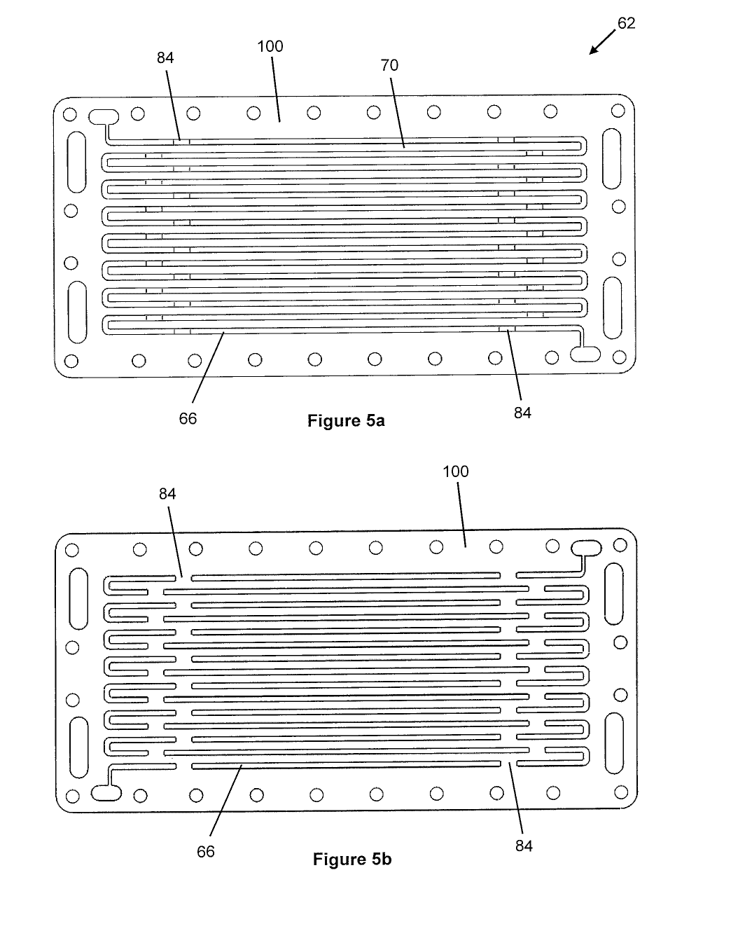

Referring now to FIG. 5a and 5b, showing the top and bottom views of fuel flow field plate 62, respectively. Fuel flow channels 66 are cut through fuel flow field plate 62 and comprise a number of fluid flow field channel supports 84 which are embossed and join fuel channel landings 70 and in several instances join with peripheral area 100. The fluid flow field channel supports 84 provide mechanical support for the fuel channel landings 70 which would otherwise be allowed to move freely, thereby maintaining the channel spacing critical for fuel flow channels 66 to maintain proper cell-to-cell fuel distribution. The fuel flow field channel supports are staggered to eliminate any residual stresses in the material which might cause material cracking.

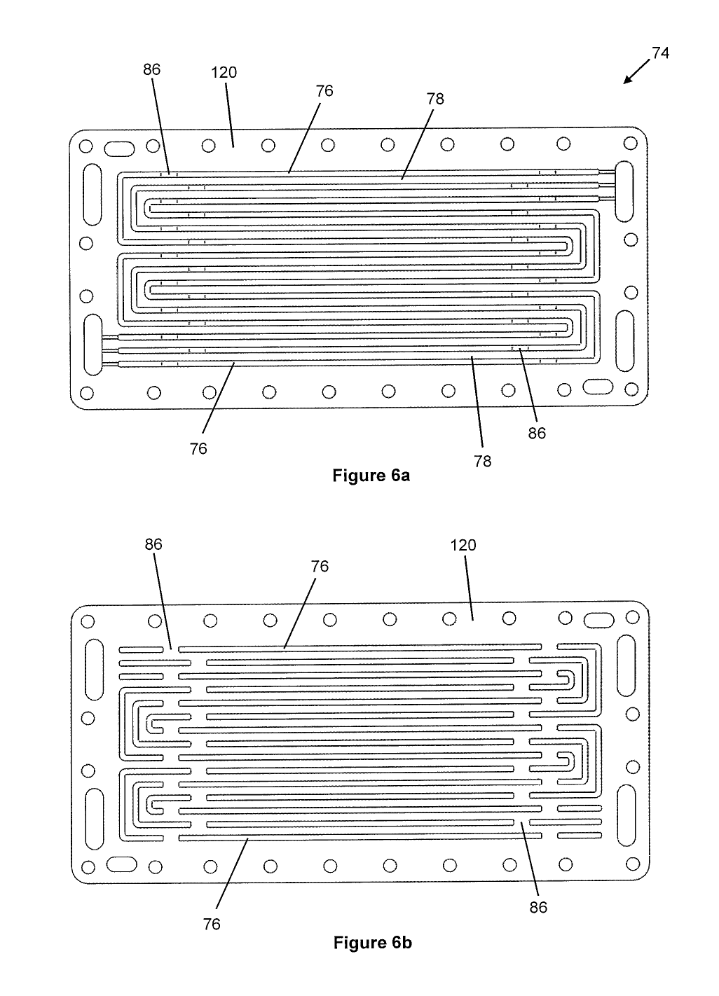

Referring now to FIG. 6a and 6b, showing the top and bottom views of coolant flow field plate 74, respectively. Shown is an example of a multi-pass serpentine flow field geometry with coolant flow channels 76 cut through coolant flow field plate 74 and comprising coolant flow field channel supports 86 which are embossed and join cooling channel landings 78 and in several instances join with peripheral area 120. The coolant flow field channel supports 86 again provide mechanical support for the coolant channel landings 78 which would otherwise be allowed to move freely, thereby maintaining the channel spacing critical for coolant flow channels 76 to maintain proper cell-to-cell coolant distribution. Likewise, the coolant flow field channel supports are staggered to eliminate any residual stresses in the material which might cause material cracking.

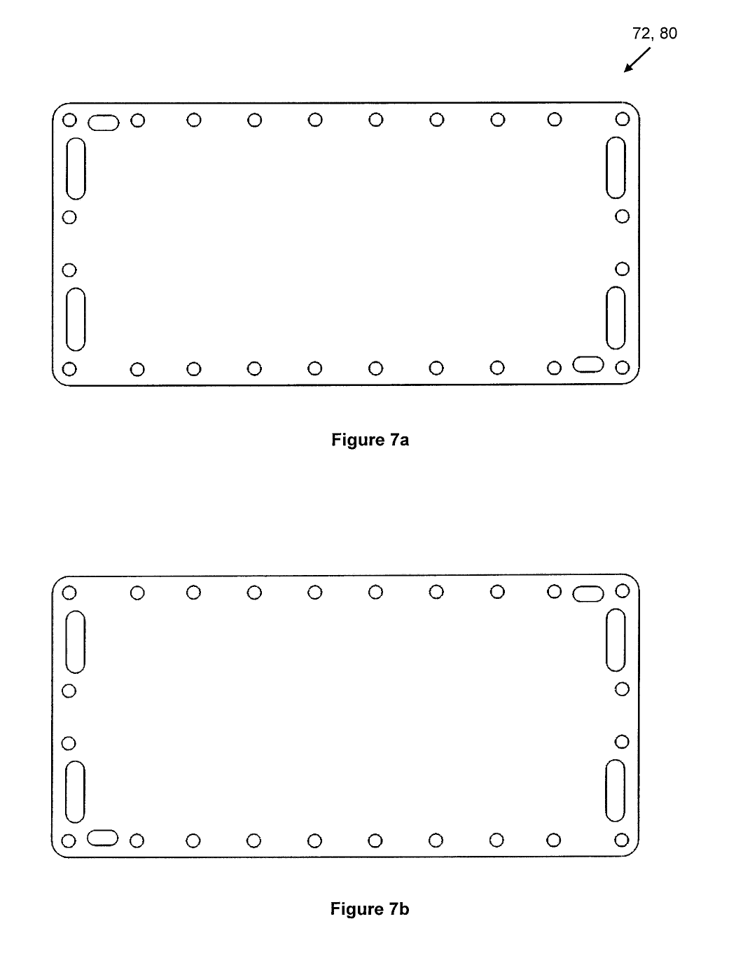

Referring now to FIG. 7a and 7b, showing the top and bottom views of separator plate 74, respectively. Since separator plate 80 is identical to separator plate 74, these figures are also an accurate representation of this component.

The fuel cell stacks described herein are particularly well suited for use in fuel cell systems for unmanned aerial vehicle (UAV) applications, which require very lightweight fuel cell systems with high energy density. Other uses for the lightweight fuel cell stacks include auxiliary power units (APUs) and small mobile applications such as scooters. Indeed, the fuel cell stacks may be useful in many other fuel cell applications such as automotive, stationary and portable power.

### Manufacturing Process—Prototype Level

Flexible graphite is used to produce the oxidant flow field plate 60, the fuel flow field plate 62, the coolant flow field plate 74, and the separator plates 72 and 80 can be purchased in roll form.

Flexible dies used in the cutting and embossing process, available from many die manufacturers, are typically used for label cutting and embossing applications and generally can fabricate hundreds of thousands of plates. The flexible die design is dependent on feature geometry and material thickness.

Typically, for the oxidant flow field plate 60, a 0.020″ thick sheet is used.

Typically, for the fuel flow field plate 62, a 0.015″ thick sheet is used.

Typically, for the coolant flow field plate 74, a 0.020″ thick sheet is used.

Typically, for the separator plates 72 and 80, a 0.015″ thick sheet is used.

### Cutting and Embossing

The oxidant flow field plate 60, the fuel flow field plate 62 and the coolant flow field plate 74 are individually cut through and embossed, and the separator plates 72 and 80 are individually cut through, using their respective flat, flexible dies using a manual, reciprocal hydraulic press.

The press cutting force varies from 10,000 lbs to 17,000 lbs, which is monitored with a pressure gauge, and which depends on the number and spacing of die features. Thus, a tightly packed die with many features requires a greater cutting force.

Once cut through and embossed, the plates 60, 62 and 74 are removed from the die with suboptimal feature definition, part deformation and jagged edges where the die cutter penetrated the flexible graphite material. Similarly, once cut through, the plates 72 and 80 are also removed from the die with suboptimal feature definition, part deformation and jagged edges where the die cutter penetrated the flexible graphite material. The scrap material that is removed during the cutting can be recycled. The dies are designed and selected in such that they cut the specific flow openings and manifold openings in the plates, as well as emboss the flow field channel supports, as illustrated in FIGS. 4, 5a, 5b, 6a, 6b, 7a and 7b.

### Finishing

After cutting through, each plate is then pressed between two flat, rigid, parallel plates in the same manual hydraulic press to improve feature tolerance, eliminate undesired deformation caused by the die, and to “flatten” rough, jagged edges left by the cutting process.

A thin layer of Teflon is the applied to the pressing fixture on either side of the plates to improve surface finish and to eliminate “sticking”. The cut through and embossed plates 60, 62, 72, 74 and 80 are then ready for stack assembly.

### Manufacturing Process—Production Level

For higher volume manufacturing, rotary die cutting is used for increased throughput. Rotary flexible dies are available from many die manufacturers. Cylindrical flexible dies are mounted on a magnetic cylinder and mate with a cylindrical anvil, where each die can use the same magnetic cylinder to reduce cost. Rotary die cutting equipment for the label making industry is used.

Flexible graphite material (available in rolls) is automatically fed into the equipment. Typically, 3000 plates per hour are potentially possible using this manufacturing method.

### Cutting

The oxidant flow field plate 60, the fuel flow field plate 62 and the coolant flow field plate 74 are individually cut through and embossed using their respective rotary, flexible dies using rotary die cutting equipment. Similarly, the separator plates 72 and 80 are individually cut through using their respective rotary, flexible dies using rotary die cutting equipment. The distance between the rotary die and anvil is adjusted to achieve optimal part cutting. An automated scrap removal system removes residual flexible graphite for recycling.

A plate handling system, which is typically a conveyor, groups and transports the cut through plates to the “finishing” area.

### Finishing

Each cut through and embossed plate is automatically fed into a rotary flattening system which comprises of two parallel rollers with Teflon coating and adjustable spacing. The finished plates are automatically removed from the rollers via conveyor and transported to their respective part bins. The plates are then ready for stack assembly.

### Alternatives

A unitary body would be fabricated using the method as described above and be mechanically or adhesively bonded together by pressing force, or using silicone adhesive, respectively; this would create a bipolar plate. For the silicone adhesive case, a thin adhesive layer would be applied to the perimeter of the plates and not to the cell's active area section to maintain intimate contact between the flexible graphite plates, thereby reducing electrical contact resistance.

A “hybrid” laminate structure is also contemplated which may include flexible graphite fluid flow channels, and a very thin aluminum or stainless steel separator plate. These subcomponents could also be mechanically or adhesively bonded together to create one part. In this case, the adhesive would again not be applied to the active area portion of the bipolar plate.

The “finishing” stage of the part fabrication could be used to increase the density of the flexible graphite and therefore improve mechanical and electrical properties (i.e. a 0.020″ thick cut part could be pressed down to 0.015″).

The plates can be fabricated with a high volume manufacturing process (reciprocal or rotary die-cutting commonly used in label making) therefore reducing overall part cost.

Parts can be fabricated using very low cost tooling (flat or cylindrical flexible dies). Moreover, flexible graphite raw material is inexpensive and is available in various forms and thicknesses.

Flexible graphite has a typical density of 1.12 g/cc. Pure graphite typically used for machining bipolar plates has a density of approximately 2.0 g/cc (1.79 times more). Graphite used for molded bipolar plates can achieve a density as low as 1.35 g/cc (1.2 times more) but requires expensive injection molding equipment and cavity dies. Additionally, flexible graphite bipolar plates fabricated via die-cutting have reduced mass because material is removed for flow channels and manifolds.

Fluid flow channel depth may be changed easily by changing the thickness of flexible graphite sheet and using same die. Also, a modular bipolar plate allows for various fuel cell configurations. For example, if more cooling is required for a specific application, a thicker cooling flow field plate can be substituted allowing higher cooling flows and heat removal.

Resulting bipolar plate is very thin (i.e. 0.015″+0.020″+0.015″+0.020″+0.015″=0.085″ thick) which reduces overall volume. An even thinner bipolar plate assembly would be possible if for instance a 0.002″ thick stainless steel separator plate was integrated (i.e. overall thickness=0.059″).

### Other Embodiments

From the foregoing description, it will be apparent to one of ordinary skill in the art that variations and modifications may be made to the embodiments described herein to adapt it to various usages and conditions.

1. A method for producing fluid flow field plates, the method comprising:
cutting through an electrically conductive sheet to create therein at least one opening for a fluid; and
embossing the sheet to create therein at least one support for the at least one opening for a fluid.

2. The method, according to claim 1, further comprising:
finishing the cut/embossed sheet by pressing it between two rigid, flat plates.

3. The method, according to claim 2, in which the rigid, flat plates each include
a non-stick coating.

4. The method, according to claim 1, further comprising:
finishing the cut sheet by pressing it between two parallel rollers.

5. The method, according to claim 4, in which the parallel rollers each include a non-stick coating.

6. The method, according to claim 1, in which the cutting step is carried out using a die having at least one blade.

7. (canceled)

8. The method, according to claim 6, in which the die is a rule die, flexible die or solid engraved die.

9. The method, according to claim 6, in which the die has two blades located side-by-side.

10. The method, according to claim 1, in which the embossing step is carried out using a die having at least one embossing feature.

11. (canceled)

12. The method, according to claim 10, in which the die is a rule die, flexible die or solid engraved die.

13. The method, according to claim 1, in which the cutting step and the embossing step are carried out simultaneously using a die having at least one blade and one embossing feature.

14. (canceled)

15. (canceled)

16. The method, according to claim Ban which the die is a rule die, flexible die or solid engraved die.

17. The method, according to claim 1, in which the cut/embossed plate includes at least one oxidant flow opening.

18. (canceled)

19. The method, according to claim 17, in which at least one oxidant inlet manifold opening and at least one oxidant outlet manifold opening are located at the ends of the oxidant flow openings and in communication therewith.

20. The method, according to claim 1, in which the cut/embossed plate includes at least one fuel inlet manifold opening and at least one fuel outlet manifold opening.

21. The method, according to claim 1, in which the cut/embossed plate includes at least one fuel flow opening.

22. (canceled)

23. The method, according to claim 21, in which the cut/embossed plate includes at least one fuel inlet manifold opening and at least one fuel outlet manifold opening which are located at the ends of the fuel flow openings and in communication therewith.

24. The method, according to claim 1, in which the cut/embossed plate includes at least, one coolant inlet manifold opening and at least one coolant outlet manifold opening.

25. The method, according to claim 1, in which the cut/embossed plate includes at least one coolant flow opening.

26. (canceled)

27. The method, according to claim 25, in which the cut/embossed plate includes at least one coolant inlet manifold opening and at least one coolant outlet manifold opening which are located at the ends of the coolant flow openings and in communication therewith.

28. The method, according to claim 1, in which the eat/embossed plate is an oxidant flow field plate, a fuel flow field plate or a coolant flow field plate.

29. (canceled)

30. (canceled)

31. The method, according to claim 1, in which the cut/embossed plate includes a plurality of oxidant inlet manifold openings and a plurality of oxidant outlet manifold openings.

32. The method, according to claim 1, in which the cut/embossed plate includes a plurality of fuel inlet manifold openings and a plurality of fuel outlet manifold openings.

33. The method, according to claim 1, in which the cat/embossed plate includes a plurality of coolant inlet manifold openings and a plurality of coolant outlet manifold openings.

34. The method, according to claim 1, in which the cut plate is a separator plate.

35. The method, according to claim 1, in which the electrically conductive sheet is flexible graphite.

36. The method, according to claim 1, in which the fluid flow field channels are trapezoidal in cross section.

37. A method for producing fluid flow field plates with complex flow field geometries, the method comprising:
cutting through an electrically conductive sheet to create therein at least one opening for a fluid; and
embossing the sheet to create therein at least one support for the at least one opening for a fluid, the cutting through and embossing steps being carried out simultaneously.
